(19) United States
(12) Patent Application Publication
(10) Pub. No.: US 2026/0307967 A1
(43) Pub. Date: Oct. 8, 2026

(54) Transport Vehicle

(71) Applicant: Daifuku Co., Ltd., Osaka-shi (JP)

(72) Inventors: Yasuhiro Yamauchi, Hinocho (JP); Keita Nakajima, Hinocho (JP); Kenji Yamada, Hinocho (JP)

(21) Appl. No.: 19/641,176

(22) Filed: Apr. 7, 2026

(30) Foreign Application Priority Data
Apr. 8, 2025 (JP) 2025-063576

(51) Int. Cl. B66F 9/075; B66F 9/065

(52) U.S. Cl. CPC B66F 9/07586; B66F 9/065

(57) ABSTRACT

A transport vehicle includes a body frame; and a support device configured to support an object to be transported. The body frame includes a first frame portion and a second frame portion arranged in a front-rear direction; and a frame connecting portion connecting the first frame portion and the second frame portion in such a manner that the first frame portion and the second frame portion are pivotable about a pivot axis extending along a width direction, and the support device includes a lift table arranged to overlap both the first frame portion and the second frame portion as viewed in a vertical direction and supported by each of the first frame portion and the second frame portion; and a lift mechanism configured to move the lift table up and down.

### CROSS-REFERENCE TO RELATED APPLICATION

This application claims priority to Japanese Patent Application No. 2025-063576 filed Apr. 8, 2025, the disclosure of which is hereby incorporated by reference in its entirety.

### BACKGROUND OF THE INVENTION

### Field of the Invention

The present invention relates to a transport vehicle including a first frame portion and a second frame portion as a body frame supported by wheels.

### Description of Related Art

In a transport vehicle (100) according to JP 2020-019348A, a frame of the transport vehicle (100) includes a first frame portion (110) and a second frame portion (111) arranged along a travel direction of the transport vehicle (100), and a roller conveyor (130) is provided on the transport vehicle (100). The first frame portion (110) and the second frame portion (111) are connected in such a manner that they are pivotable about an axis extending along the rotational axis of a drive wheel (108). Further, the first frame portion (110) and a transport vehicle main body (110a) are connected in such a manner that they are pivotable about an axis extending along the rotational axis of the drive wheel (108). The second frame portion (111) and the transport vehicle main body (110a) are connected in such a manner that they are pivotable about an axis extending along the rotational axis of the drive wheel (108) and are slidable in the travel direction of the transport vehicle (100).

With such a configuration, even when there are irregularities or changes in inclination on a travel surface, it is possible to maintain a state where the drive wheel (108) is in contact with the travel surface and to allow the transport vehicle (100) to travel appropriately.

With the transport vehicle according to JP 2020-019348A, it is possible to move objects to be transported, for example, in a width direction orthogonal to the travel direction of the transport vehicle by the roller conveyor provided on the transport vehicle. However, due to the structure for transferring objects to be transported to and from a transport destination of the objects to be transported with the use of the roller conveyor, the transport destination also needs to be provided with a transfer mechanism matching the height of the roller conveyor. Therefore, for example, in a case where work is to be performed on objects to be transported at the transport destination and a height suitable for the work is different from the height of the roller conveyor, there is a problem that it may be difficult to perform the work easily.

### SUMMARY OF THE INVENTION

Therefore, realization of a transport vehicle capable of facilitating work on objects to be transported at the transport destination is desired.

A transport vehicle according to the present disclosure includes: a body frame; a plurality of wheels configured to support the body frame; and a support device configured to support an object to be transported. The body frame has a longer dimension in a front-rear direction than in a width direction as viewed in a vertical direction, and includes: a first frame portion and a second frame portion that are arranged in the front-rear direction; and a frame connecting portion connecting the first frame portion and the second frame portion in such a manner that the first frame portion and the second frame portion are pivotable about a pivot axis extending along the width direction, the plurality of wheels include: at least one first wheel configured to support the first frame portion; and at least one second wheel configured to support the second frame portion, at least one of the at least one first wheel and the at least one second wheel includes at least one drive wheel driven by a drive source, and the support device includes: a lift table arranged to overlap both the first frame portion and the second frame portion as viewed in the vertical direction and supported by each of the first frame portion and the second frame portion; and a lift mechanism configured to move the lift table up and down.

With this configuration, the body frame includes the first frame portion and the second frame portion that are arranged in the front-rear direction and the frame connecting portion connecting them in such a manner that they are pivotable about a pivot axis, and therefore, even if the body frame has a longer dimension in the front-rear direction than in the width direction as viewed in the vertical direction, it is possible to prevent the wheels from being lifted from the travel surface due to the influence of unevenness of the travel surface. Therefore, the traveling stability of the transport vehicle can be enhanced. Further, since the support device includes the lift table arranged to overlap both the first frame portion and the second frame portion as viewed in the vertical direction and supported by each of the first frame portion and the second frame portion, an object to be transported that is long in the front-rear direction or a plurality of objects to be transported arranged in the front-rear direction can be appropriately supported by the lift table. Furthermore, since the support device includes the lift mechanism configured to move the lift table up and down, the object to be transported supported by the lift table can be moved up and down. Therefore, work on the object to be transported, such as assembly work and transfer work at a transport destination, can be facilitated.

Further features and advantages of the technology according to the present disclosure will become more apparent from the following description of exemplary and non-limiting embodiments described with reference to the drawings.

### BRIEF DESCRIPTION OF THE DRAWINGS

FIG. 1 is a side view of a transport vehicle according to an embodiment.

FIG. 2 is a bottom view of the transport vehicle shown in FIG. 1.

FIG. 3 is a bottom view of a lift table shown in FIG. 1.

FIG. 4 is a top view of a lift mechanism shown in FIG. 1.

FIG. 5 is a diagram illustrating movement of the lift table shown in FIG. 1.

FIG. 6 is a diagram showing a state in which the transport vehicle shown in FIG. 1 travels on a travel surface having an inclined portion.

FIG. 7 is a diagram showing a state in which the lift table shown in FIG. 1 is raised on the travel surface having the inclined portion.

### DESCRIPTION OF THE INVENTION

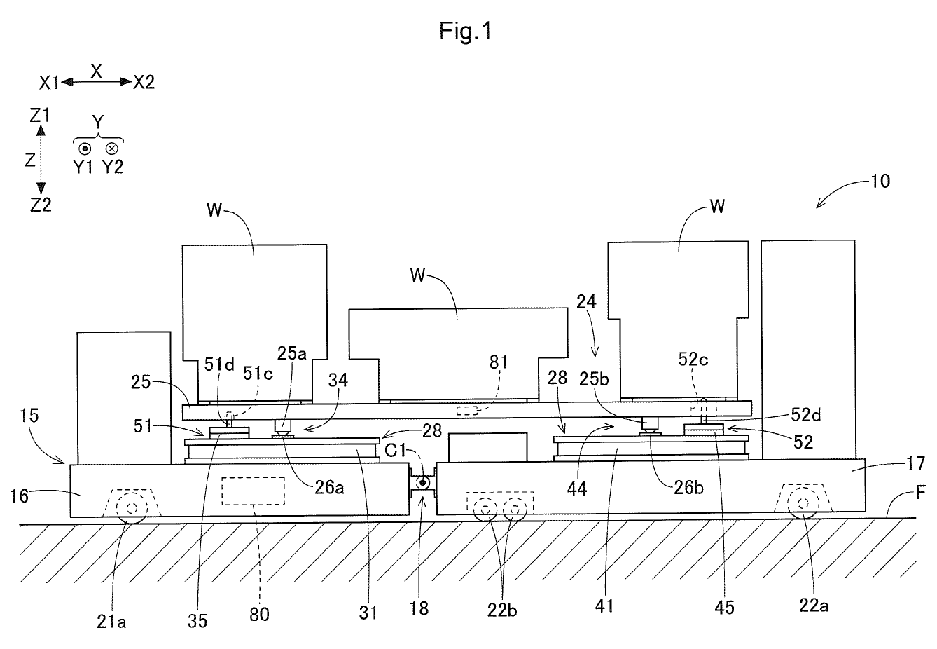

Hereinafter, an embodiment of a transport vehicle 10 will be described with reference to the drawings. FIG. 1 is a schematic diagram showing an example of a side surface of the transport vehicle 10. The transport vehicle 10 travels on a travel surface F to transport objects W to be transported. Examples of the objects W to be transported include goods, parts, transport containers, and the like. In the present embodiment, the objects W to be transported are large-sized parts to be attached to a vehicle.

Examples of the transport vehicle 10 include an electric vehicle, a vehicle equipped with an internal combustion engine, and the like. In the present embodiment, the transport vehicle 10 is an unmanned vehicle. Examples of the unmanned vehicle include a vehicle that performs autonomous traveling, a vehicle that performs traveling by remote control, and the like. Examples of the travel surface F include a travel path provided in a facility such as a building or a ship, a floor of a facility, and the like.

The transport vehicle 10 includes a body frame 15. The body frame 15 includes a first frame portion 16, a second frame portion 17, and a frame connecting portion 18. The body frame 15 has a longer dimension in a front-rear direction X than in a width direction Y as viewed in a vertical direction.

One side in the front-rear direction X is defined as a front-rear direction first side X1. The other side in the front-rear direction X is defined as a front-rear direction second side X2. In the present embodiment, the longitudinal direction of the transport vehicle 10 is the front-rear direction X. In the present embodiment, a direction orthogonal to the front-rear direction X is the width direction Y. One side in the width direction Y is defined as a width direction first side Y1. The other side in the width direction Y is defined as a width direction second side Y2.

The first frame portion 16 and the second frame portion 17 are arranged in the front-rear direction X. In the present embodiment, the first frame portion 16 is disposed on the front-rear direction first side X1 with respect to the second frame portion 17. In the present embodiment, the front-rear direction first side X1 is the front side relative to the transport vehicle 10.

The frame connecting portion 18 connects the first frame portion 16 and the second frame portion 17 in such a manner that they are pivotable about a pivot axis C1 extending along the width direction Y. In the present embodiment, the pivot axis C1 is parallel to the width direction Y. Note that the pivot axis C1 may be slightly inclined with respect to the width direction Y. For example, the pivot axis C1 may be an axis inclined at ±20 degrees or less with respect to the width direction Y, or an axis that allows pivoting in a plurality of directions. For example, the frame connecting portion 18 may be a ball joint or a universal joint.

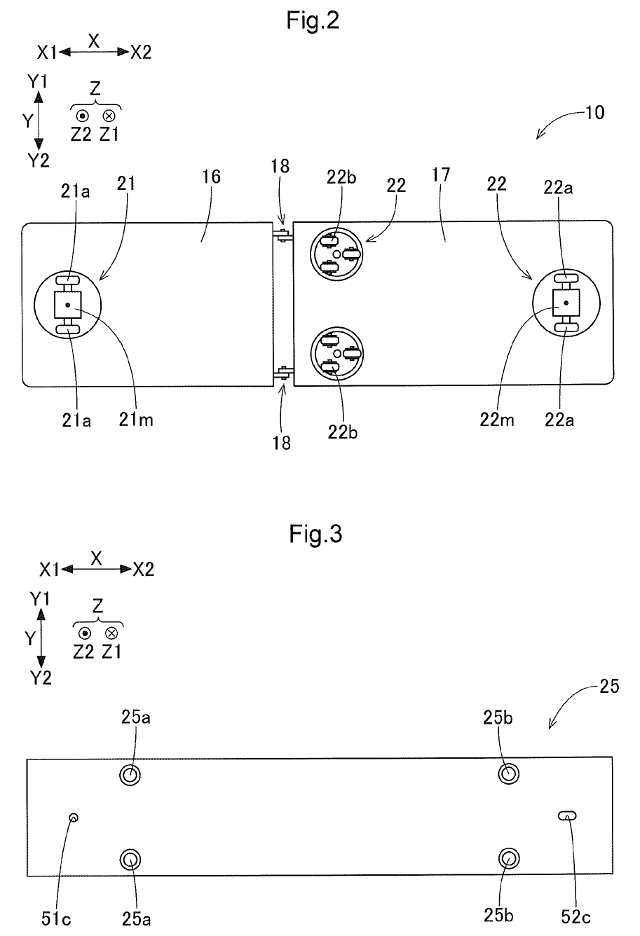

FIG. 2 is a schematic diagram showing an example of a bottom surface of the transport vehicle 10. The transport vehicle 10 includes a plurality of wheels. The plurality of wheels support the body frame 15. The plurality of wheels include first wheels 21 and second wheels 22. The first wheels 21 support the first frame portion 16. The second wheels 22 support the second frame portion 17. In the present embodiment, the plurality of wheels include a plurality of first wheels 21 and a plurality of second wheels 22. In the present embodiment, the plurality of wheels include a plurality of second wheels 22 separated in the front-rear direction X.

At least one of the first wheels 21 and the second wheels 22 includes a drive wheel driven by drive sources. In the present embodiment, the drive sources include a first drive source 21m and a second drive source 22m.

The first wheels 21 include first drive wheels 21a, which are drive wheels. The first drive wheels 21a are driven by the first drive source 21m. The first drive wheels 21a and the first drive source 21m are configured to be integrally pivotable about an axis extending along the vertical direction Z.

The second wheels 22 include second drive wheels 22a, which are drive wheels. The second drive wheels 22a are driven by the second drive source 22m. The second drive wheels 22a and the second drive source 22m are configured to be integrally pivotable about an axis extending along the vertical direction Z.

The second wheels 22 include second idler wheels 22b. The second idler wheels 22b are configured to be pivotable about an axis extending along the vertical direction Z.

The first drive wheels 21a are disposed on the front-rear direction first side X1 relative to the center position in the front-rear direction X of the first frame portion 16. In the present embodiment, the first drive wheels 21a are disposed at an end portion on the front-rear direction first side X1 of the first frame portion 16.

The second drive wheels 22a are disposed on the front-rear direction second side X2 relative to the center position in the front-rear direction X of the second frame portion 17. In the present embodiment, the second drive wheels 22a are disposed at an end portion on the front-rear direction second side X2 of the second frame portion 17.

The second idler wheels 22b are disposed on the front-rear direction first side X1 relative to the center position in the front-rear direction X of the second frame portion 17. In the present embodiment, the second idler wheels 22b are disposed at an end portion on the front-rear direction first side X1 of the second frame portion 17. Since the second idler wheels 22b are disposed at the end portion on the front-rear direction first side X1 of the second frame portion 17 in this manner, when the first frame portion 16 and the second frame portion 17 pivot about the pivot axis C1 in a direction in which the frame connecting portion 18 approaches the travel surface F, it is possible to prevent the frame connecting portion 18 from coming into contact with the travel surface F.

As shown in FIG. 1, the transport vehicle 10 includes a support device 24 that supports the objects W to be transported. The support device 24 includes a lift table 25. The support device 24 includes a lift mechanism 28 for moving the lift table 25 up and down.

FIG. 3 is a schematic diagram showing an example of a bottom surface of the lift table 25. As shown in FIGS. 1 and 3, the lift table 25 is disposed in such a manner as to overlap both the first frame portion 16 and the second frame portion 17 as viewed in the vertical direction. The lift table 25 is supported by the first frame portion 16 and the second frame portion 17.

The lift mechanism 28 includes a first lifting section 31 for moving first supported portions 25a described later up and down. The first lifting section 31 is disposed between the first frame portion 16 and the lift table 25.

The lift table 25 includes the first supported portions 25a supported by the first frame portion 16. In the present embodiment, the first supported portions 25a are supported by first support portions 26a in such a manner as to allow relative movement in the front-rear direction X and the width direction Y with respect to the first lifting section 31. The first supported portions 25a are supported by the first support portions 26a in such a manner as to allow tilting at least about an axis extending along the width direction Y with respect to the first lifting section 31. The first supported portions 25a are supported by the first support portions 26a in such a manner as to allow tilting about an axis extending along the front-rear direction X with respect to the first lifting section 31. The first supported portions 25a are supported by the first support portions 26a in such a manner as to allow tilting about an axis extending along the vertical direction Z with respect to the first lifting section 31.

By the first supported portions 25a and the first support portions 26a, the lift table 25 is supported with respect to the first frame portion 16 in such a manner as to allow tilting at least about an axis extending along the width direction Y. In the illustrated example, the first support portions 26a are plate-like members provided on the first lifting section 31. In the illustrated example, the first supported portions 25a are ball casters.

The lift mechanism 28 includes a second lifting section 41 for moving second supported portions 25b described later up and down. The second lifting section 41 is disposed between the second frame portion 17 and the lift table 25. The second lifting section 41 is configured to be able to move the second supported portions 25b up and down independently of the first lifting section 31.

The lift table 25 includes the second supported portions 25b supported by the second frame portion 17. In the present embodiment, the second supported portions 25b are supported by second support portions 26b in such a manner as to allow relative movement in the front-rear direction X and the width direction Y with respect to the second lifting section 41. The second supported portions 25b are supported by the second support portions 26b in such a manner as to allow tilting at least about an axis extending along the width direction Y with respect to the second lifting section 41. The second supported portions 25b are supported by the second support portions 26b in such a manner as to allow tilting about an axis extending along the front-rear direction X with respect to the second lifting section 41. The second supported portions 25b are supported by the second support portions 26b in such a manner as to allow tilting about an axis extending along the vertical direction Z with respect to the second lifting section 41.

By the second supported portions 25b and the second support portions 26b, the lift table 25 is supported with respect to the second frame portion 17 in such a manner as to allow tilting at least about an axis extending along the width direction Y. In the illustrated example, the second support portions 26b are plate-like members provided on the second lifting section 41. In the illustrated example, the second supported portions 25b are ball casters.

The support device 24 includes a first guide mechanism 34. The lift table 25 is supported by the first frame portion 16 via the first guide mechanism 34. The first guide mechanism 34 allows relative movement between the lift table 25 and the first frame portion 16 in at least one of the front-rear direction X and the width direction Y. In the present embodiment, the first guide mechanism 34 allows relative movement between the lift table 25 and the first frame portion 16 in the front-rear direction X and the width direction Y. In the present embodiment, the first guide mechanism 34 includes the first supported portions 25a and the first support portions 26a.

The support device 24 includes a second guide mechanism 44. The lift table 25 is supported by the second frame portion 17 via the second guide mechanism 44. The second guide mechanism 44 allows relative movement between the lift table 25 and the second frame portion 17 in at least one of the front-rear direction X and the width direction Y. In the present embodiment, the second guide mechanism 44 allows relative movement between the lift table 25 and the second frame portion 17 in the front-rear direction X and the width direction Y. In the present embodiment, the second guide mechanism 44 includes the second supported portions 25b and the second support portions 26b.

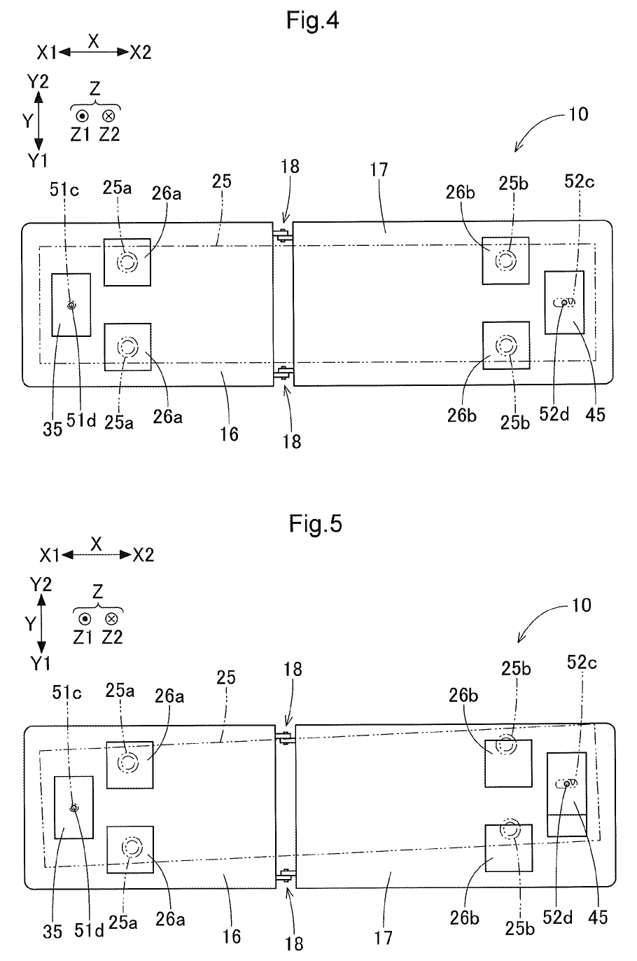

FIG. 4 is a schematic diagram showing an example of a top surface of the lift mechanism 28. FIG. 5 is a diagram illustrating movement of the lift table 25 by a first moving device 35 and a second moving device 45.

The first guide mechanism 34 includes the first moving device 35. The first moving device 35 moves the first supported portions 25a relative to the first frame portion 16 in the front-rear direction X and the width direction Y. In the present embodiment, the first moving device 35 moves the first supported portions 25a by moving a first connecting portion 51 (described later) with respect to the first frame portion 16. In the present embodiment, the first moving device 35 moves a first frame-side connecting portion 51d (described later) with respect to the first frame portion 16. The structure of the first moving device 35 is not particularly limited, but examples thereof include an XY table in which two stages supported by linear roller guides are stacked, or the like.

The second guide mechanism 44 includes the second moving device 45. The second moving device 45 moves the second supported portion 25b relative to the second frame portion 17 in the front-rear direction X and the width direction Y. In the present embodiment, the second moving device 45 moves the second supported portion 25b by moving a second connecting portion 52 (described later) with respect to the second frame portion 17. In the present embodiment, the second moving device 45 moves a second frame-side connecting portion 52d (described later) with respect to the second frame portion 17. The structure of the second moving device 45 is not particularly limited, and examples thereof include an XY table in which two stages supported by linear roller guides are stacked, or the like.

The transport vehicle 10 includes the first connecting portion 51 connecting the first lifting section 31 and the lift table 25. The first connecting portion 51 allows tilting of the lift table 25 with respect to the first frame portion 16 at least about an axis extending along the width direction Y. In the present embodiment, the first connecting portion 51 includes a first table-side connecting portion 51c and the first frame-side connecting portion 51d. In the present embodiment, the first table-side connecting portion 51c is a spherical bushing, and the first frame-side connecting portion 51d is a pin inserted into the spherical bushing.

The first connecting portion 51 allows relative movement of the lift table 25 with respect to the first frame portion 16 in the vertical direction Z. In the present embodiment, the first frame-side connecting portion 51d is biased to an upper side Z1 by a biasing member (not shown). In this way, most of the load of the lift table 25 on the first frame portion 16 can be received not by the first connecting portion 51 but by the first supported portions 25a.

The transport vehicle 10 includes the second connecting portion 52 connecting the second lifting section 41 and the lift table 25. The second connecting portion 52 allows tilting of the lift table 25 with respect to the second frame portion 17 at least about an axis extending along the width direction Y. In the present embodiment, the second connecting portion 52 includes a second table-side connecting portion 52c and the second frame-side connecting portion 52d. In the present embodiment, the second table-side connecting portion 52c is an elongated hole provided in the lift table 25, and the second frame-side connecting portion 52d is an insertion member inserted into the elongated hole.

The second connecting portion 52 allows relative movement of the lift table 25 with respect to the second frame portion 17 in at least the front-rear direction X. In the present embodiment, the second connecting portion 52 allows relative movement of the lift table 25 with respect to the second frame portion 17 in the vertical direction Z. In this way, most of the load of the lift table 25 on the second frame portion 17 can be received not by the second connecting portion 52 but by the second supported portions 25b.

The second frame-side connecting portion 52d is an elongated hole elongated in the front-rear direction X. Therefore, the second connecting portion 52 allows relative movement of the lift table 25 with respect to the second frame portion 17 in at least the front-rear direction X.

The first connecting portion 51 restricts relative movement of the lift table 25 with respect to the first frame-side connecting portion 51d in the front-rear direction X. The first connecting portion 51 restricts relative movement of the lift table 25 with respect to the first frame-side connecting portion 51d in the width direction Y. The first connecting portion 51 restricts relative movement of the lift table 25 with respect to the first frame-side connecting portion 51d in the vertical direction Z.

The first connecting portion 51 allows tilting of the lift table 25 with respect to the first frame-side connecting portion 51d about an axis along the front-rear direction X. The first connecting portion 51 allows tilting of the lift table 25 with respect to the first frame-side connecting portion 51d about an axis extending along the vertical direction Z.

The second connecting portion 52 allows relative movement of the lift table 25 with respect to the second frame-side connecting portion 52d in the front-rear direction X. The second connecting portion 52 restricts relative movement of the lift table 25 with respect to the second frame-side connecting portion 52d in the width direction Y. The second connecting portion 52 allows relative movement of the lift table 25 with respect to the second frame-side connecting portion 52d in the vertical direction Z.

The second connecting portion 52 restricts tilting of the lift table 25 with respect to the second frame-side connecting portion 52d about an axis extending along the front-rear direction X. The second connecting portion 52 allows tilting of the lift table 25 with respect to the second frame-side connecting portion 52d about an axis extending along the vertical direction Z.

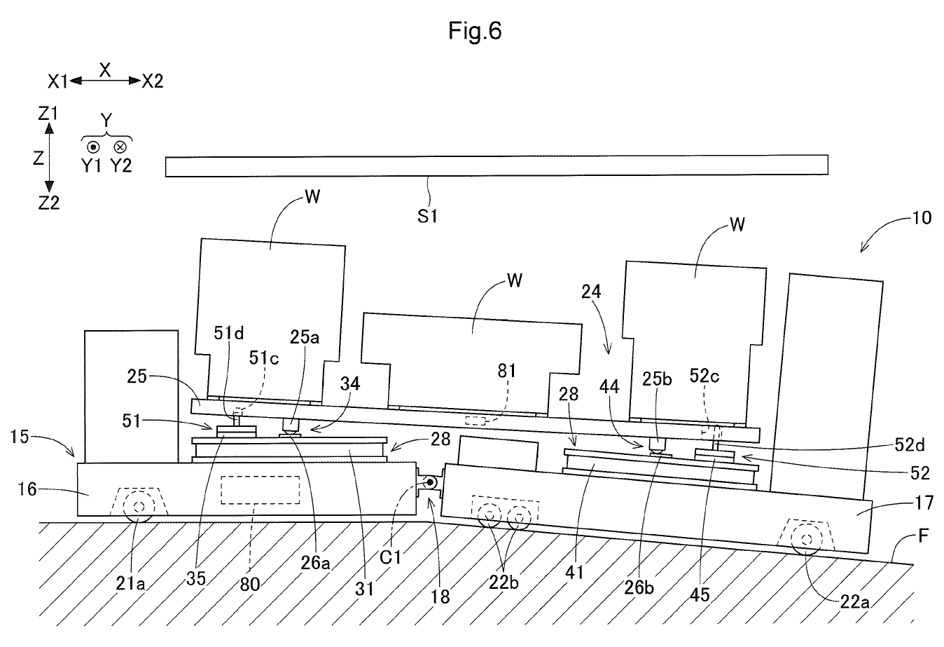

FIG. 6 is a schematic diagram showing a state in which the transport vehicle 10 travels on the travel surface F having an inclined portion. In the example shown in FIG. 6, the tilt of the lift table 25 is made smaller than the inclination of the inclined portion of the travel surface F by the first connecting portion 51 and the second connecting portion 52.

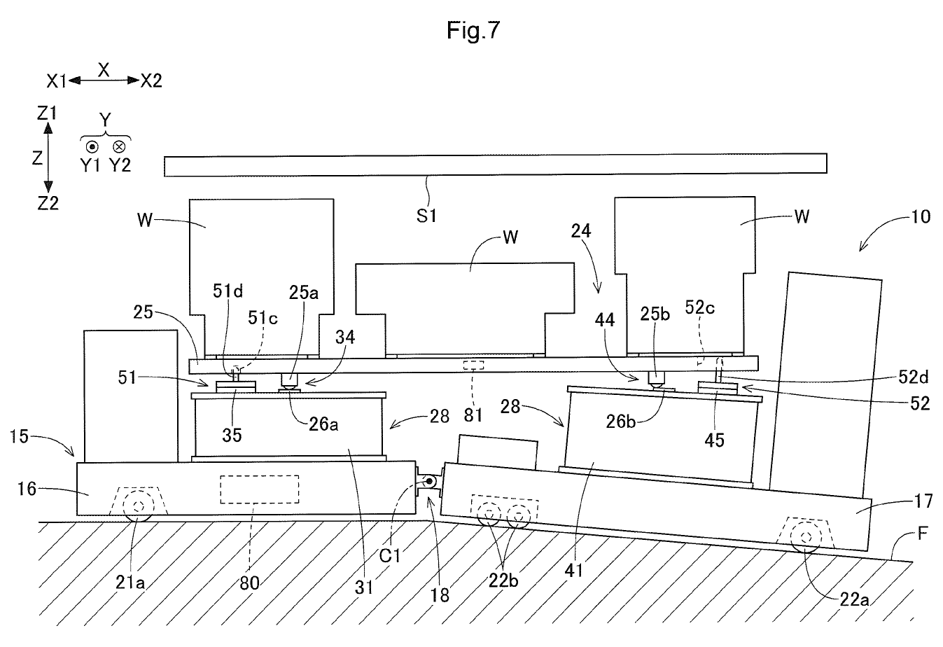

FIG. 7 is a schematic diagram illustrating control of the first lifting section 31 and the second lifting section 41 by a lifting controller 80. The transport vehicle 10 includes the lifting controller 80. The lifting controller 80 controls the first lifting section 31. The lifting controller 80 controls the second lifting section 41. The lifting controller 80 controls the first moving device 35. The lifting controller 80 controls the second moving device 45. The lifting controller 80 executes at least one of first angle control and second angle control, which are described later.

The lifting controller 80 includes a control device having an arithmetic processing unit such as a CPU (Central Processing Unit), and a main storage device such as a RAM (Random Access Memory) or a ROM (Read Only Memory), which can be referred to by the arithmetic processing unit. Each function of the control device is realized by cooperation between hardware provided in the control device and a program executed on the hardware such as the arithmetic processing unit. In the present embodiment, the control device (specifically, the arithmetic processing unit provided in the control device) functions as a “computer”. A part of the lifting controller 80 may be provided in an external facility, for example, an external server such as a cloud server.

The lifting controller 80 performs the “first angle control” for controlling the respective lifting amounts of the first lifting section 31 and the second lifting section 41 in such a manner as to bring the angle of the lift table 25 closer to a reference angle, based on the result of detection by a detection device 81 that detects the angle of the lift table 25 with respect to a reference surface S1 set at the transport destination of the objects W to be transported.

The detection device 81 may be provided at one location or a plurality of locations. For example, the detection device 81 may be provided on each of the front-rear direction first side X1 and the front-rear direction second side X2 of the lift table 25. For example, the detection device 81 may be provided on the body frame 15.

The detection device 81 may be provided in the transport vehicle 10, or may be installed in a facility at the transport destination of the objects W to be transported. The angle of the lift table 25 detected by the detection device 81 includes an angle about an axis extending along the width direction Y. Note that the angle of the lift table 25 detected by the detection device 81 may include an angle about an axis extending along the front-rear direction X or an angle about an axis extending along the vertical direction Z. Examples of the detection device 81 include a plurality of distance measuring instruments, an imaging device, a coordinate detection device using sound waves, infrared rays, or the like, a displacement measuring instrument, a magnetic angle sensor, and the like. The detection device 81 corresponds to the “angle detection device”.

Examples of the reference surface S1 include one surface of an attachment target object to which the objects W to be transported are attached at the transport destination, one surface of a reference member fixed at the transport destination, and the like. Examples of the reference angle include an angle set according to the attachment target object to which the objects W to be transported are attached, an angle set for each transport destination, the same angle as the angle of the reference surface S1, and the like. The reference angle is set, for example, for each reference surface S1. A plurality of reference angles may be set for one reference surface S1. In this way, work on the objects W to be transported at the transport destination can be facilitated.

In the first angle control, the lifting controller 80 further controls respective movement amounts of the first moving device 35 and the second moving device 45 in such a manner as to bring the angle of the lift table 25 closer to the reference angle, based on the result of detection by the detection device 81 detecting the angle of the lift table 25 about the axis extending along the vertical direction Z with respect to the reference surface S1 set at the transport destination of the objects W to be transported. FIG. 5 shows an example of control of the respective movement amounts of the first moving device 35 and the second moving device 45 by the lifting controller 80.

In the first angle control, based on the result of detection by the detection device 81 detecting the positions of the lift table 25 in the front-rear direction X and the width direction Y with respect to reference positions set at the transport destination of the objects W to be transported, the lifting controller 80 further controls respective movement amounts of the first moving device 35 and the second moving device 45 in such a manner as to bring the positions of the lift table 25 in the front-rear direction X and the width direction Y closer to the reference positions.

By performing the first angle control, even in a case where, for example, the inclination of the travel surface F at the transport destination is liable to change and the angle between the first frame portion 16 and the second frame portion 17 changes, the lift table 25 can be maintained at the reference angle.

The lifting controller 80 performs the “second angle control” for controlling the respective lifting amounts of the first lifting section 31 and the second lifting section 41 in such a manner as to make the angle of the lift table 25 with respect to the reference surface S1 set at the transport destination of the objects W to be transported equal the reference angle, in accordance with lifting amount data of each of the first lifting section 31 and the second lifting section 41 stored in advance in association with the position of the body frame 15 on the travel surface F.

In the second angle control, the lifting controller 80 further controls the respective movement amounts of the first moving device 35 and the second moving device 45 in such a manner as to make the angle of the lift table 25 about the axis extending along the vertical direction Z with respect to the reference surface S1 set at the transport destination of the objects W to be transported equal the reference angle, in accordance with movement amount data of each of the first moving device 35 and the second moving device 45 stored in advance in association with the position of the body frame 15 on the travel surface F. FIG. 5 shows an example of control of the respective movement amounts of the first moving device 35 and the second moving device 45 by the lifting controller 80.

In the second angle control, the lifting controller 80 further controls the respective movement amounts of the first moving device 35 and the second moving device 45 in such a manner as to make the position of the lift table 25 in the front-rear direction X and the width direction Y equal the reference position set at the transport destination of the objects W to be transported, in accordance with movement amount data of each of the first moving device 35 and the second moving device 45 stored in advance in association with the position of the body frame 15 on the travel surface F.

By performing the second angle control, for example, it is possible to learn the relationship between the coordinates indicating the position of the transport vehicle 10 and past movement amount data of each of the first moving device 35 and the second moving device 45, and maintain the lift table 25 at the reference angle.

As the lifting amount of the first lifting section 31, for example, the lifting amount of the first supported portions 25a, the first support portions 26a, the first connecting portion 51, or the like can be used. As the movement amount of the first moving device 35, for example, the movement amount of the first support portions 26a, the first connecting portion 51, or the like can be used.

As the lifting amount of the second lifting section 41, for example, the lifting amount of the second supported portions 25b, the second support portions 26b, the second connecting portion 52, or the like can be used. As the movement amount of the second moving device 45, for example, the movement amount of the second supported portions 25b, the second support portions 26b, the second connecting portion 52, or the like can be used.

### Next, other embodiments of the transport vehicle 10 will be described.

1 In the above embodiment, the configuration in which the body frame 15 includes the first frame portion 16 and the second frame portion 17 that is disposed on the front-rear direction second side X2 with respect to the first frame portion 16 has been described as an example. However, the embodiment of the transport vehicle 10 is not limited to such a configuration. For example, the first frame portion 16 or the second frame portion 17 may be constituted by a plurality of frame portions. For example, a third frame portion supported by a third wheel may be disposed on the front-rear direction first side X1 of the first frame portion 16 or the front-rear direction second side X2 of the second frame portion 17.
2 In the above embodiment, a configuration has been described as an example in which the front-rear direction first side X1 is the front side relative to the transport vehicle 10, the first drive wheels 21a are disposed on the front-rear direction first side X1 relative to the center position of the first frame portion 16 in the front-rear direction X, the second drive wheels 22a are disposed on the front-rear direction second side X2 relative to the center position of the second frame portion 17 in the front-rear direction X, and the second idler wheels 22b are disposed on the front-rear direction first side X1 relative to the center position of the second frame portion 17 in the front-rear direction X. However, the embodiment of the transport vehicle 10 is not limited to such a configuration. For example, the front-rear direction first side X1 may be the rear side relative to the transport vehicle 10. For example, the second idler wheels 22b may be disposed on the front-rear direction second side X2 relative to the center position of the second frame portion 17 in the front-rear direction X. For example, the transport vehicle 10 may not include the first drive wheels 21a or the second drive wheels 22a. For example, the transport vehicle 10 may not include the second idler wheels 22b.
3 In the above embodiment, a configuration has been described as an example in which the lift mechanism 28 includes the first lifting section 31 and the second lifting section 41. However, the embodiment of the transport vehicle 10 is not limited to such a configuration. For example, the lift mechanism 28 may not include the first lifting section 31 and the second lifting section 41, and a single lifting section may be configured to lift both the first supported portions 25a and the second supported portions 25b.
4 In the above embodiment, a configuration has been described as an example in which the first connecting portion 51 allows tilting of the lift table 25 with respect to the first frame portion 16 about axes extending along the front-rear direction X, the width direction Y, and the vertical direction Z, and the second connecting portion 52 allows tilting of the lift table 25 with respect to the second frame portion 17 about axes extending along the width direction Y and the vertical direction Z and relative movement of the lift table 25 with respect to the second frame portion 17 in at least the front-rear direction X and the vertical direction Z. However, the embodiment of the transport vehicle 10 is not limited to such a configuration. For example, the first connecting portion 51 may be configured to restrict tilting of the lift table 25 with respect to the first frame portion 16 about any or all of the axes extending along the front-rear direction X, the width direction Y, and the vertical direction Z. For example, the second connecting portion 52 may be configured to restrict tilting of the lift table 25 with respect to the second frame portion 17 about any or all of the axes extending along the front-rear direction X, the width direction Y, and the vertical direction Z.
5 In the above embodiment, a configuration has been described as an example in which a spherical bushing is used for the first connecting portion 51, an elongated hole and an insertion member are used for the second connecting portion 52, ball casters are used for the first supported portions 25a and the second supported portions 25b, and plate-like members are used for the first support portions 26a and the second support portions 26b. However, the embodiment of the transport vehicle 10 is not limited to such a configuration. For example, the first supported portions 25a and the second supported portions 25b may be slide members. For example, the first support portions 26a and the second support portions 26b may be ball casters. For example, a link mechanism, various types of joints, various types of bearings, or the like may be used for the first connecting portion 51 or the second connecting portion 52. For example, the first connecting portion 51 may also serve as both the first supported portions 25a and the first support portions 26a. For example, the second connecting portion 52 may also serve as both the second supported portions 25b and the second support portions 26b.
6 In the above embodiment, a configuration has been described as an example in which the support device 24 includes a first guide mechanism 34 and a second guide mechanism 44, and the lift table 25 is supported by the first frame portion 16 via the first guide mechanism 34 and by the second frame portion 17 via the second guide mechanism 44. However, the embodiment of the transport vehicle 10 is not limited to such a configuration. For example, the support device 24 may not include either one or both of the first guide mechanism 34 and the second guide mechanism 44.
7 In the above embodiment, a configuration has been described as an example in which the angles of the lift table 25 detected by the detection device 81 include the angle about the axis extending along the width direction Y, the angle about the axis extending along the front-rear direction X, and the angle about the axis extending along the vertical direction Z, and the lifting controller 80 performs the first angle control. However, the embodiment of the transport vehicle 10 is not limited to such a configuration. For example, the angles of the lift table 25 detected by the detection device 81 may not include any of the angle about the axis extending along the width direction Y, the angle about the axis extending along the front-rear direction X, and the angle about the axis extending along the vertical direction Z. For example, in the first angle control, the respective movement amounts of the first moving device 35 and the second moving device 45 may not be controlled. For example, the lifting controller 80 may be configured to perform first horizontal control to control the respective lifting amounts of the first lifting section 31 and the second lifting section 41, based on the result of detection by a sensor detecting the tilting of the lift table 25, in such a manner as to bring the surface of the lift table 25 facing the upper side Z1 closer to horizontal.
8 In the above embodiment, a configuration has been described as an example in which the lifting controller 80 controls the respective lifting amounts of the first lifting section 31 and the second lifting section 41 and controls the respective movement amounts of the first moving device 35 and the second moving device 45 in the second angle control. However, the embodiment of the transport vehicle 10 is not limited to such a configuration. For example, in the second angle control, the respective movement amounts of the first moving device 35 and the second moving device 45 may not be controlled. For example, the lifting controller 80 may be configured to perform second horizontal control to control the respective lifting amounts of the first lifting section 31 and the second lifting section 41 in accordance with lifting amount data of each of the first lifting section 31 and the second lifting section 41 stored in advance in association with the position of the body frame 15 on the travel surface F so that the surface of the lift table 25 facing the upper side Z1 becomes horizontal.
9 In the above embodiment, a configuration has been described as an example in which the lifting controller 80 controls the first moving device 35 and the second moving device 45. However, the embodiment of the transport vehicle 10 is not limited to such a configuration. For example, the first guide mechanism 34 may not include the first moving device 35, and the first supported portions 25a may be manually moved relative to the first frame portion 16 in the front-rear direction X and the width direction Y and fixed. For example, the second guide mechanism 44 may not include the second moving device 45, and the second supported portions 25b may be manually moved relative to the second frame portion 17 in the front-rear direction X and the width direction Y and fixed. For example, the first guide mechanism 34 and the second guide mechanism 44 may be configured with the use of a floating mechanism.
10 Note that the configurations disclosed in the above-described embodiment may be applied in combination with configurations disclosed in other embodiments as long as no contradiction arises. Regarding other configurations as well, the embodiments disclosed in the present specification are merely examples in all respects. Therefore, various modifications can be made as appropriate within the scope of the present disclosure.

Hereinafter, a transport vehicle according to the present disclosure will be described.

According to one aspect, a transport vehicle includes: a body frame; a plurality of wheels configured to support the body frame; and a support device configured to support an object to be transported. The body frame has a longer dimension in a front-rear direction than in a width direction as viewed in a vertical direction, and includes: a first frame portion and a second frame portion that are arranged in the front-rear direction; and a frame connecting portion connecting the first frame portion and the second frame portion in such a manner that the first frame portion and the second frame portion are pivotable about a pivot axis extending along the width direction, the plurality of wheels include: at least one first wheel configured to support the first frame portion; and at least one second wheel configured to support the second frame portion, at least one of the at least one first wheel and the at least one second wheel includes at least one drive wheel driven by a drive source, and the support device includes: a lift table arranged to overlap both the first frame portion and the second frame portion as viewed in the vertical direction and supported by each of the first frame portion and the second frame portion; and a lift mechanism configured to move the lift table up and down.

With this configuration, the body frame includes the first frame portion and the second frame portion that are arranged in the front-rear direction and the frame connecting portion connecting them in such a manner that they are pivotable about a pivot axis, and therefore, even if the body frame has a longer dimension in the front-rear direction than in the width direction as viewed in the vertical direction, it is possible to prevent the wheels from being lifted from the travel surface due to the influence of unevenness of the travel surface. Therefore, the traveling stability of the transport vehicle can be enhanced. Further, since the support device includes the lift table arranged to overlap both the first frame portion and the second frame portion as viewed in the vertical direction and supported by each of the first frame portion and the second frame portion, an object to be transported that is long in the front-rear direction or a plurality of objects to be transported arranged in the front-rear direction can be appropriately supported by the lift table. Furthermore, since the support device includes the lift mechanism configured to move the lift table up and down, the object to be transported supported by the lift table can be moved up and down. Therefore, work on the object to be transported, such as assembly work and transfer work at a transport destination, can be facilitated.

According to one aspect, with a front-rear direction first side being one side in the front-rear direction, and a front-rear direction second side being the other side in the front-rear direction, the first frame portion is disposed on the front-rear direction first side with respect to the second frame portion, the at least one first wheel includes a first drive wheel included in the at least one drive wheel, the first drive wheel is disposed on the front-rear direction first side relative to a center position of the first frame portion in the front-rear direction, the at least one second wheel includes: a second drive wheel included in the at least one drive wheel; and a second idler wheel, the second drive wheel is disposed on the front-rear direction second side relative to a center position of the second frame portion in the front-rear direction, and the second idler wheel is disposed on the front-rear direction first side relative to the center position of the second frame portion in the front-rear direction.

With this configuration, the body frame can be stably supported by the drive wheels and the idler wheels. Further, the drive wheels arranged on both sides in the front-rear direction enable the transport vehicle to travel stably.

According to one aspect, the lift table includes: a first supported portion supported by the first frame portion; and a second supported portion supported by the second frame portion, the lift mechanism includes: a first lifting section configured to move the first supported portion up and down; and a second lifting section configured to move the second supported portion up and down independently of the first lifting section, and the transport vehicle further includes: a first connecting portion connecting the first lifting section and the lift table and configured to allow tilting of the lift table with respect to the first frame portion at least about an axis extending along the width direction; and a second connecting portion connecting the second lifting section and the lift table and configured to allow tilting of the lift table with respect to the second frame portion at least about an axis extending along the width direction, and relative movement of the lift table with respect to the second frame portion at least in the front-rear direction.

With this configuration, the lift table can be appropriately moved up and down by the first lifting section and the second lifting section. Further, even when the first frame portion and the second frame portion connected via the frame connecting portion pivot relative to each other, it is possible to prevent a large load from acting between the lift table and the lift mechanism.

According to one aspect, the support device includes: a first guide mechanism configured to allow relative movement between the lift table and the first frame portion in the front-rear direction and the width direction; and a second guide mechanism configured to allow relative movement between the lift table and the second frame portion in the front-rear direction and the width direction, and the lift table is supported by the first frame portion via the first guide mechanism and by the second frame portion via the second guide mechanism.

With this configuration, the object to be transported supported by the lift table is allowed to move relative to the body frame in the front-rear direction and the width direction. Therefore, assembly work, transfer work, and the like at the transport destination of the object to be transported can be facilitated.

According to one aspect, the lift table includes :a first supported portion supported by the first frame portion; and a second supported portion supported by the second frame portion, the lift mechanism includes: a first lifting section configured to move the first supported portion up and down; a second lifting section configured to move the second supported portion up and down independently of the first lifting section; and a lifting controller configured to control the first lifting section and the second lifting section, and the lifting controller performs at least one of: a first angle control for controlling respective lifting amounts of the first lifting section and the second lifting section in such a manner as to bring an angle of the lift table closer to a reference angle, based on a result of detection by an angle detection device configured to detect the angle of the lift table with respect to a reference surface set at a transport destination of the object to be transported; and a second angle control for controlling respective lifting amounts of the first lifting section and the second lifting section in such a manner as to make the angle of the lift table with respect to the reference surface equal the reference angle, in accordance with lifting amount data of each of the first lifting section and the second lifting section stored in advance in association with a position of the body frame on a travel surface.

With this configuration, even when the first frame portion and the second frame portion connected via the frame connecting portion pivot relative to each other, it is possible to maintain the lift table at an angle close to the reference angle.

The transport vehicle according to the present disclosure only needs to exhibit at least one of the effects described above.

What is claimed is:

1. A transport vehicle comprising:
a body frame;
a plurality of wheels configured to support the body frame; and
a support device configured to support an object to be transported,
wherein the body frame has a longer dimension in a front-rear direction than in a width direction as viewed in a vertical direction, and comprises:
a first frame portion and a second frame portion that are arranged in the front-rear direction; and
a frame connecting portion connecting the first frame portion and the second frame portion in such a manner that the first frame portion and the second frame portion are pivotable about a pivot axis extending along the width direction,
wherein the plurality of wheels comprise:
at least one first wheel configured to support the first frame portion; and
at least one second wheel configured to support the second frame portion,
wherein at least one of the at least one first wheel and the at least one second wheel comprises at least one drive wheel driven by a drive source, and
wherein the support device comprises:
a lift table arranged to overlap both the first frame portion and the second frame portion as viewed in the vertical direction and supported by each of the first frame portion and the second frame portion; and
a lift mechanism configured to move the lift table up and down.

2. The transport vehicle according to claim 1, wherein:
with a front-rear direction first side being one side in the front-rear direction, and a front-rear direction second side being the other side in the front-rear direction, the first frame portion is disposed on the front-rear direction first side with respect to the second frame portion,
the at least one first wheel comprises a first drive wheel included in the at least one drive wheel,
the first drive wheel is disposed on the front-rear direction first side relative to a center position of the first frame portion in the front-rear direction,
the at least one second wheel comprises:
a second drive wheel included in the at least one drive wheel; and
a second idler wheel,
the second drive wheel is disposed on the front-rear direction second side relative to a center position of the second frame portion in the front-rear direction, and
the second idler wheel is disposed on the front-rear direction first side relative to the center position of the second frame portion in the front-rear direction.

3. The transport vehicle according to claim 1, wherein:
the lift table comprises:
a first supported portion supported by the first frame portion; and
a second supported portion supported by the second frame portion,
the lift mechanism comprises:
a first lifting section configured to move the first supported portion up and down; and
a second lifting section configured to move the second supported portion up and down independently of the first lifting section, and
the transport vehicle further comprises:
a first connecting portion connecting the first lifting section and the lift table and configured to allow tilting of the lift table with respect to the first frame portion at least about an axis extending along the width direction; and
a second connecting portion connecting the second lifting section and the lift table and configured to allow tilting of the lift table with respect to the second frame portion at least about an axis extending along the width direction, and relative movement of the lift table with respect to the second frame portion at least in the front-rear direction.

4. The transport vehicle according to claim 1,
wherein the support device comprises: a first guide mechanism configured to allow relative movement between the lift table and the first frame portion in the front-rear direction and the width direction; and a second guide mechanism configured to allow relative movement between the lift table and the second frame portion in the front-rear direction and the width direction, and
wherein the lift table is supported by the first frame portion via the first guide mechanism and by the second frame portion via the second guide mechanism.

5. The transport vehicle according to claim 1, wherein:
the lift table comprises:
a first supported portion supported by the first frame portion; and
a second supported portion supported by the second frame portion,
the lift mechanism comprises:
a first lifting section configured to move the first supported portion up and down;
a second lifting section configured to move the second supported portion up and down independently of the first lifting section; and
a lifting controller configured to control the first lifting section and the second lifting section, and
the lifting controller performs at least one of:
a first angle control for controlling respective lifting amounts of the first lifting section and the second lifting section in such a manner as to bring an angle of the lift table closer to a reference angle, based on a result of detection by an angle detection device configured to detect the angle of the lift table with respect to a reference surface set at a transport destination of the object to be transported; and
a second angle control for controlling respective lifting amounts of the first lifting section and the second lifting section in such a manner as to make the angle of the lift table with respect to the reference surface equal the reference angle, in accordance with lifting amount data of each of the first lifting section and the second lifting section stored in advance in association with a position of the body frame on a travel surface.
